(19) United States
(12) Patent Application Publication
(10) Pub. No.: US 2016/0019670 A1
(43) Pub. Date: Jan. 21, 2016

(54) CUSTOMER RELATIONSHIP MANAGEMENT MAILING APPARATUS AND METHOD

(71) Applicant: Joshua Latimer, Fenton, MI (US)

(72) Inventor: Joshua Latimer, Fenton, MI (US)

(21) Appl. No.: 14/337,129

(22) Filed: Jul. 21, 2014

(51) Int. Cl. G06Q 50/32; G06Q 30/00

(52) U.S. Cl. CPC G06Q 50/32; G06Q 30/01; G06Q 2250/70

(57) ABSTRACT

An apparatus and method for sending mailings by using a widget that is integrated with a customer relationship management website, which uses customer data from within the CRM.

### FIELD OF THE INVENTION

This invention relates to a computer program, mobile application, and system to manage the mailing of items, such as a postcard, by integrating a widget or module with a customer relationship management website.

### BACKGROUND OF THE INVENTION

Online postcard sending services such as, www.sendoutcards.com are the currently the most typical type of user interface for sending cards from online resources.

There is a need for a customer relationship management (CRM) website to have a mobile app that can create a database containing homes and corresponding addresses, and allow people access to the database.

There is a need to use iframes, javascript, and other technologies that can be embedded into a CRM website.

There is also a need for such a mobile app to direct that the house be mailed a mail piece or post card.

### REFERENCE NUMERALS LIST

10 present invention, customer relationship management mailing apparatus and method.

20 customer relationship management website or mobile app (CRM website or app)

30 integrated and customizeable mail sending application

40 customer relationship management program (CRM program)

50 customer relationship management entity (CRM entity)

60 third party entity

70 variable data printer

80 application programming interface (API)

90 customer record

100 customer data

110 street bidder app

120 merge fields

130 street bidder account

140 credits

150 user interface

160 integrated widget

170 automated trigger

190 entering a customer record

200 customer record

210 indicating that a postcard should be sent

220 choosing a template

230 verifying that all necessary information needed to send a postcard is present in the customer record

240 asking for permission to use the amount of credits necessary to send the postcard and gain authorization

250 sending postcard data to printer

260 sending card to customer

270 importing customer contact information from existing CRM

280 user

290 populating the necessary merge fields

300 logging in

310 making postcard template modifications

320 purchasing a credit

330 integrated widget

340 clicking inside customer record

350 clicking inside a first pop-up window

360 clicking inside a second pop-up window

370 clicking to send post card to printer and then customer

380 automated campaign

390 postcard module

400 partner

410 importing customer contact from CRMs

420 partner account

430 signing in and/or registering of partner

440 pay

450 payment notification

460 billing report

470 transaction

480 credit usage

490 postcard send status

500 install widget

510 the partner widget

520 sign in or credit view

530 purchase credits

540 pay

550 handle payment notification

560 sending post cards to specific people in CRM

570 viewing credits history

580 customizing post card design

590 importing contact information from CRM website

600 adding post card widget to existing system

610 integrating with post card printer

620 front end framework

630 layout

640 widget

650 back end

660 postcard

670 processing a credit card payment

680 managing payments of CRM website and app users

690 user information

700 credit card payment gateway

710 application framework

720 database

### SUMMARY OF THE INVENTION

One aspect of the present invention is a widget 640 integrated with a customer relationship management website or mobile app(CRM website or app) 20 for mailing items to customers from within the CRM website or app 20, comprising the steps of: indicating that a postcard should be sent 210; choosing a template 220 to be used that has been authorized and customized a s a usable template; verifying that all of the necessary contact information needed to send a postcard is present in the customer's record 230; asking for permission to use the amount of credits necessary to send the postcard and gain authorization 240; sending postcard data to the printer 250; and sending the postcard from the printer to the customer 260.

Another aspect is a customer relationship management website, also referred to herein as a mobile app, or a CRM website or app, 20 has an integrated and customizable mail sending application 30; said mail sending application (30) may be owned by a third party entity 60, an entity separate from the customer relationship management entity 50 that may own the app 20;
said customer relationship management entity 50 transacts with said third party entity 60;
a user 280 can order that a postcard 660 be sent by the step of clicking to send postcard to printer and then customer 370, and the step of clicking to send postcard to printer and then customer 370 is managed by a third party entity 60;
said third party entity 60 manages a transaction 470, such as a credit card processing transaction 470;

said app 20 can be integrated with an Application Programming Interface (API) 80 so that when said user 280 performs the clicking to send post card to printer and then customer 370 from within a customer record 200, that customer's data 100 will populate the necessary merge fields 120;

said CRM website 20 user 280 performs the logging in 300 step to said third party entity 60 portion of their app separately so that they can use the technology of the third party entity 60;

this allows said user 280 to see their usage, perform the making postcard template modifications 310 step, and the step of clicking to send post cards to printer and then customer 370; there will be a technology built to allow for CRM websites or apps 20 that use automated triggers 170 to integrate the step of clicking to send postcard to printer and then customer 370 as part of the CRM entity's 50 automated trigger campaigns 380.

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of one embodiment of the relationship between the CRM entity and the third party entity;

FIG. 3 is a schematic diagram of an embodiment of the steps of sending a postcard from the CRM website or app; and

FIG. 4 is a schematic diagram of an embodiment of the steps of how one could use the partner account.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

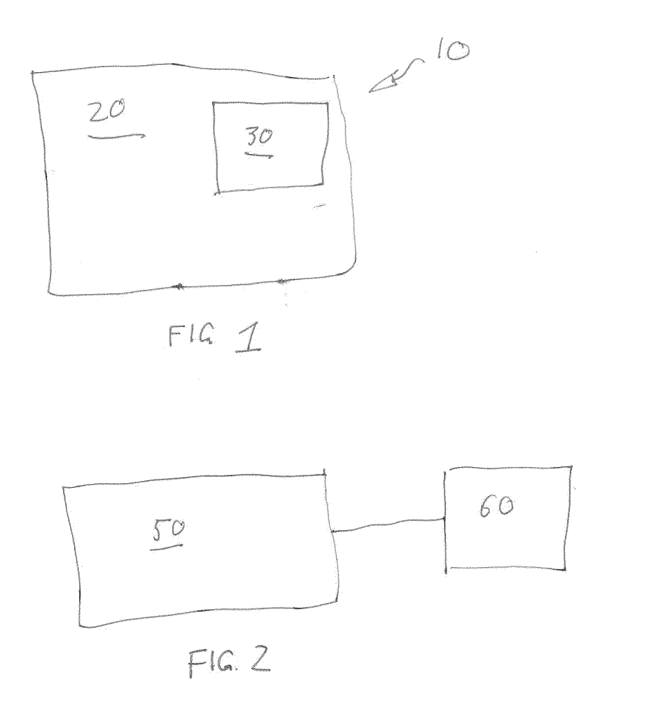

FIG. 1 illustrates one embodiment where the customer relationship management website or mobile app (“CRM website or app”) 20 has an integrated and customizable mail sending application 30. This mail sending application 30 may be owned by a third party entity 60, and entity separate from the customer relationship management entity (“CRM entity”) 50 that may own the CRM website or app 20.

FIG. 2 illustrates an embodiment where the customer relationship management entity 50 transacts with a third party entity 60. For example, while a user 280 may be using the CRM website 20, the user 280 may order that a postcard 660 be sent by the step of clicking to send postcard to printer and then customer 370, and the step of clicking to send postcard to printer and then customer 370 is managed by a third party entity 60.

In one embodiment a third party entity 60 manages a transaction 470, such as a credit card processing transaction 470.

The CRM website or app 20 can be integrated with an Application Programming Interface (API) 80 so that when the user 280 performs the clicking to send post card to printer and then customer 370 from within a customer record 200, that customer's data 100 will populate the necessary merge fields 120.

The CRM website 20 user 280 may have to perform the logging in 300 step to the third party entity 60 portion of their app separately so that they can use the technology of the third party entity 60. One example of a suitable third party entity is an app created by www.streetbidder.com This allows a user 280 and see their usage, perform the making postcard template modifications 310 step, and the step of clicking to send post cards to printer and then customer 370.

Clicking to send post cards to printer and then customer 370 using a third party entity 60 may then reduce the number of “credits” 140 of the user 280. The credits 140 may be managed by a third party entity 60. The credits 140 can be purchased from within the CRM website or app 20 one of the third party entity's 60 integrated widgets. One such integrated widget 160 may be an integrated and customizable mail sending application 30. The integrated widget 160 may also be referred to as a module 160.

There will be a technology built to allow for CRM websites or apps 20 that use automated triggers 170 to integrate the step of clicking to send postcard to printer and then customer 370 as part of the CRM entity's 50 automated trigger campaigns 380. As an example, this part of the CRM website or app 20 will allow users 280 to perform the step of clicking to send post cards to printer and then customer postcards 370 instead of emails as certain steps of their automated marketing.

In one embodiment, the third party entity 60 will have one or more partners 400. In this embodiment, the partner 400 may be a CRM entity 50. The third party entity 60 may integrate a simple and customizable postcard sending service with the CRM website and app 20.

The technology used by the CRM website and app 20 is completely separate from the technology of the CRM website and app 20 that the third party entity 60 integrates with. The third party entity 60 interface, such as the widgets, buttons, and reporting features act as if they are actually native to the CRM website and app 20 that the third party entity 60 integrates with. By making use of iframes, javascript, and other technologies that can be embedded into the CRM website and app 20 used by the third party entity 60, it is possible for the third party entity 60, such as www.streetbidder.com to conduct the step of processing a credit card payment 670, and the steps of managing payments of CRM website and app users 680, customizing post card design 580, and sending postcard data to printer 250.

The present invention 10 has key points of integration. For example, The CRM entity 50 will be responsible to tie into the third party entity's 60 API 80 so that when the user 280 performs the sending the postcard from the printer to the customer 260 from within a customer record 90, that customer's data 100 will populate the necessary merge fields 120. The CRM website and app 20 user 280 will have to login to the third party entity 60, such as www.streetbidder.com portion of the CRM website and app 20 separately so that the user 280 can use the third party entity's 60 technology and see the user information 690, such as usage, postcard template modifications, and sent post cards.

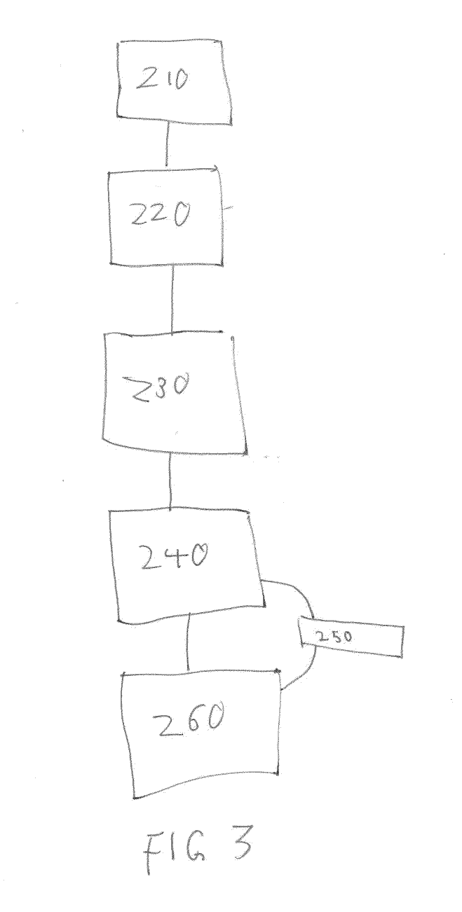

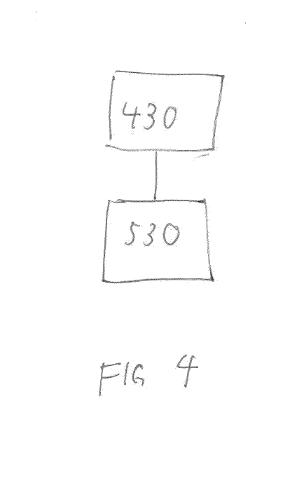

FIG. 3 illustrates one embodiment of using the present invention 10. For example, after entering a customer's record 90, it would be possible to simply send specific postcards 660 within just a few clicks or steps as discussed below.

The first step may be performed while the user is at the customer record 90, and this may be the step of indicating that a postcard should be sent 210.

The second step may be performed while the user is at a popup window, this may be the step of choosing a template 220 to be used that has been authorized and customized as a usable template in another widget previously.

The third step may be performed at a popup window. This step may be verifying that all of the necessary contact information needed to send a postcard is present in the customer's record 230.

The fourth step may also be performed in a popup window. This step may be asking for permission to use the amount of credits necessary to send the postcard and gain authorization 240.

The fifth step may be sending the postcard data to printer 250, and then sending the postcard from the printer to the customer 260.

The automated trigger 170 setup would be similar, but positioned inside the area of the CRM website or app 20 where the automated trigger campaigns 380 are built. The user 280 experience that makes this special is that the postcard 660 sending process is so tightly integrated into the CRM website or app 20 that it feels very much like it's part of the CRM website or app 20 and makes sending a postcard 660 so simple and effortless.

In one embodiment there may be a certain system architecture design of the third party entity 60 module or widget 640. In one embodiment the present invention may be used as follows. The third party entity 60 module or widget 640 may be a module in a website of the third party entity, such as www.streetbid.net where partners 400 can manage and send a postcard 660 thru their existing CRM website or app 20. The third party entity 60 can import customer's data 100 from existing CRM website or app 20 and make the contacts available for sending a postcard 660.

FIG. 4 illustrates one embodiment of what is referred to as at partner account 420. This partner account 420 may be used as follows.

The first step may be the step of signing in and/or registering of a partner 430. The second step may be the step of purchasing credits 530. This may be performed through a credit card payment gateway, such as www.zooz.com. Such a gateway is one way to handle payment notification 550. The credit card payment gateway 700 may provide a billing report, information regarding transactions, credit usage, and postcard 660 sent status, such as when and what postcards were sent.

In one embodiment the CRM website or app 20 may add a partner widget 640. A user 280 may perform the step of logging in 300. Here the user may be able to view their credit usage 480. The CRM website or app 20 may have capability to handle payment notification 550 and sending post cards to specific people in the CRM website or app 20, such as customer's data 100. The CRM website or app 20 may have capability to allow the user 280 to perform the step of viewing credit history 570, and customizing post card design 580.

In one embodiment, the present invention 10 may integrate with the existing partner CRM website or app 20 as discussed below.

Customer's data 100 may be imported from their existing CRM system can be via web services and the application programming interface API. Partners 400 can add the postcard widget or module 640 in their existing CRM website and app 20 to allow the user 280 to send a postcard 660. The third party entity 60 may send a http post request with image attachment to printer for printing, this may be referred to as the step of sending postcard data to printer 250.

In one embodiment the present invention 10 may have the following system architecture. The front end framework 620 may have a layout 630. In one embodiment the layout 630 may have a Zurb(R) foundation. In one embodiment the widget 640 may use JavaScript to output the html iFrame.

The present invention 10 may have a back end 650. The back end 650 may have an application framework 710. The framework may by constructed using cakePHP. The customer's data 100 may be stored on a database 720. The database 720 may be stored on a server. One example of a suitable server may be provided by amazon web services (“AWS”). The database 720 can be hosted by any suitable server is suitable. One such is an open source database such as mySQL. A variable data printer 70 may be used to send post cards to customers. One such printer may be http post request. The billing and money transactions may be managed by the third party entity 60, or a merchant service provider may be used, such as www.zooz.com, or any other gateway web service may be integrated with the API 80. The importing of customer's data 100 or customer record 90 may be imported from the CRM website or app 20 to the API 80. To extract customer's data 100, one suitable vehicle may be Representational State Transfer, (REST). One example may be provided at http://book.cakephp.org2.0/en/development/rest.html.

I claim:

1. A widget (640) integrated with a customer relationship management website or mobile app(20) for mailing items to customers from within the customer relationship management website or mobile app(20), comprising the steps of:
indicating that a postcard should be sent (210);
choosing a template (220) to be used that has been authorized and customized as a usable template;
verifying that all of the necessary contact information needed to send a postcard is present in the customer's record(230);
asking for permission to use the amount of credits necessary to send the postcard and gain authorization (240);
sending the postcard data to printer (250); and
sending the postcard from the printer to the customer (260).

2. A customer relationship management website, also referred to herein as a mobile app, or a CRM website or app, (20)(has an integrated and customizable mail sending application (30); said mail sending application (30) may be owned by a third party entity (60), an entity separate from the customer relationship management entity (50) that may own the app (20);
said customer relationship management entity (50) transacts with said third party entity (60);
a user (280) can order that a postcard (660) be sent by the step of clicking to send postcard to printer and then customer (370), and the step of clicking to send postcard to printer and then customer (370) is managed by a third party entity (60);
said third party entity (60) manages a transaction (470), such as a credit card processing transaction (470);
said app (20) can be integrated with an Application Programming Interface (API) (80) so that when said user (280) performs the clicking to send post card to printer and then customer (370) from within a customer record (200), that customer's data (100) will populate the necessary merge fields (120);
said CRM website (20) user (280) performs the logging in (300) step to said third party entity (60) portion of their app separately so that they can use the technology of the third party entity (60);
this allows said user (280) to see their usage, perform the making postcard template modifications (310) step, and the step of clicking to send post cards to printer and then customer (370);
there will be a technology built to allow for CRM websites or apps (20) that use automated triggers (170) to integrate the step of clicking to send postcard to printer and then customer (370) as part of the CRM entity's (50) automated trigger campaigns (380).
